(19) United States
(12) Patent Application Publication
(10) Pub. No.: US 2025/0243865 A1
(43) Pub. Date: Jul. 31, 2025

(54) COUNTER-ROTATING FAN AND HEAT DISSIPATING DEVICE

(71) Applicants: CHAMP TECH OPTICAL (FOSHAN) CORPORATION, Foshan (CN); Foxconn Technology Co., Ltd., New Taipei (TW)

(72) Inventors: XIAO-GUANG MA, Foshan (CN); Zheng LUO, Foshan (CN); Peng-Fei MAI, Foshan (CN); Yung-Ping LIN, New Taipei (CN); Yong-Kang ZHANG, Shenzhen (CN)

(21) Appl. No.: 18/639,484

(22) Filed: Apr. 18, 2024

(30) Foreign Application Priority Data
Jan. 30, 2024 (CN) 202410134116.8

(51) Int. Cl. F04D 19/02; F04D 29/52; F04D 29/58

(52) U.S. Cl. CPC F04D 19/024; F04D 29/522; F04D 29/582

(57) ABSTRACT

A counter-rotating fan includes a frame, an inlet fan, and an output fan. The inlet fan is disposed in the frame. The inlet fan includes an inlet body and a plurality of inlet blades. The inlet blades are spaced apart from each other and disposed around the inlet body. The output fan is disposed in the frame and opposite to the inlet fan. The output fan includes an output body and a plurality of output blades. The output blades are spaced apart from each other and disposed around the output body. A rotational direction of the output blades is opposite to a rotational direction of the inlet blades, an end of each o output blade away from the output body curves towards the inlet blades. The present disclosure further provides a heat dissipating device.

### FIELD

The subject matter herein generally relates to heat dissipation, and more particularly, to a counter-rotating fan and a heat dissipating device.

### BACKGROUND

A counter-rotating fan is installed in a heat dissipating device to dissipate heat generated by an electronic element in the heat dissipating device. However, a surface area of fan blades of the counter-rotating fan affects a working efficiency of the counter-rotating fan, and noise generated by the fan blades during rotation is large. Therefore, there is a room for improvement in the art.

### BRIEF DESCRIPTION OF THE DRAWINGS

Implementations of the present technology will now be described, by way of example only, with reference to the attached figures.

FIG. 1 is a diagrammatic view of an embodiment of a counter-rotating fan according to an embodiment of the present disclosure.

FIG. 2 is similar to FIG. 1, but showing the counter-rotating fan from another angle.

FIG. 3 is a diagrammatic view of an inlet frame of the counter-rotating fan of FIG. 1.

FIG. 4 is an exploded view of an area IV of the inlet frame of FIG. 3.

FIG. 5 is a diagrammatic view of an output frame of the counter-rotating fan of FIG. 1.

FIG. 6 is an exploded view of the counter-rotating fan of FIG. 1.

FIG. 7 is a diagrammatic view of an output blade of FIG. 6.

FIG. 8 is a cross-sectional view of the counter-rotating fan taken along line VIII-VIII of FIG. 1.

FIG. 9 is a diagrammatic view of an embodiment of a heat dissipating device according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like. Some embodiments of the present disclosure will be described in detail with reference to the drawings. If no conflict, the following embodiments and features in the embodiments can be combined with each other.

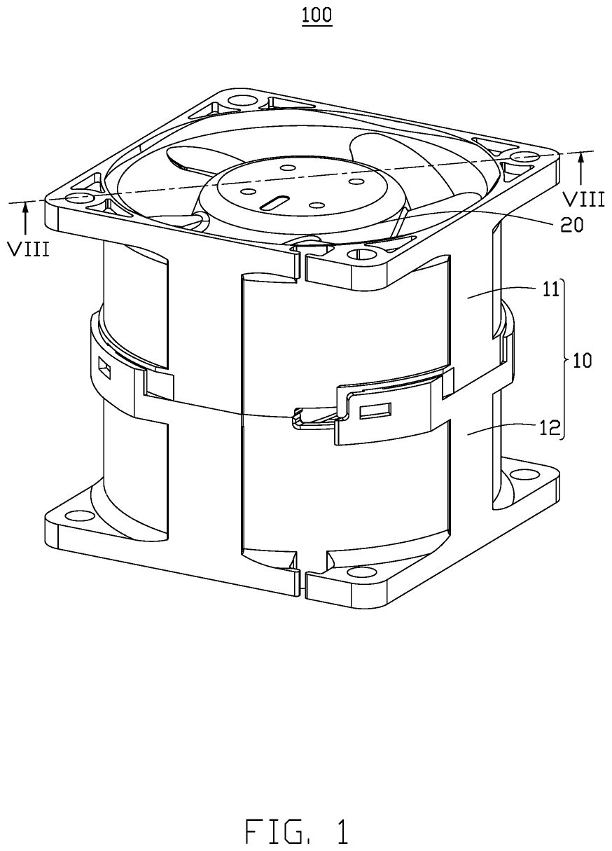

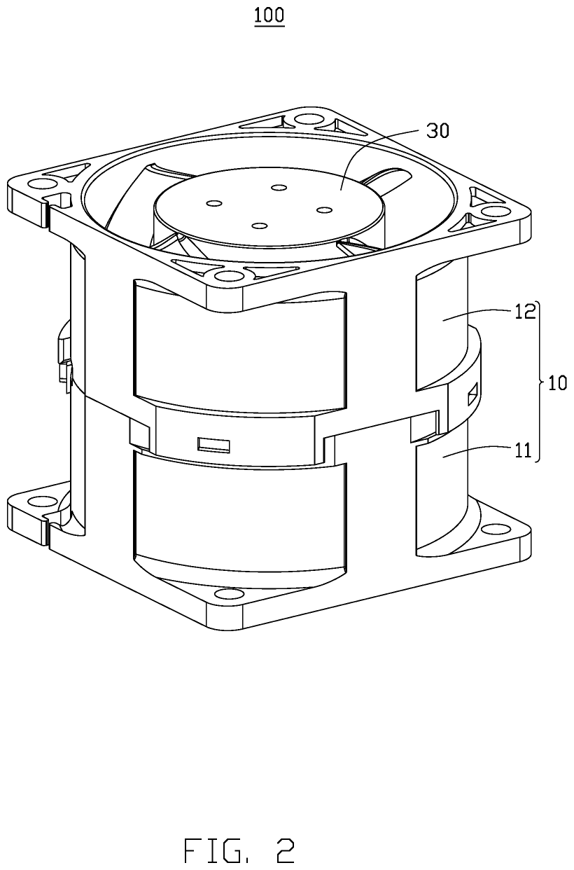

Referring to FIGS. 1 and 2, a counter-rotating fan 100 is provided according to an embodiment of the present disclosure. The counter-rotating fan 100 includes a frame 10, an inlet fan 20, and an output fan 30.

The frame 10 includes an inlet frame 11 and an output frame 12. The inlet frame 11 and the output frame 12 are opposite to each other. Both the inlet frame 11 and the output frame 12 are hollow and cylindrical. An interior of the inlet frame 11 can install the inlet fan 20, and an interior of the output frame 12 can install the output fan 30.

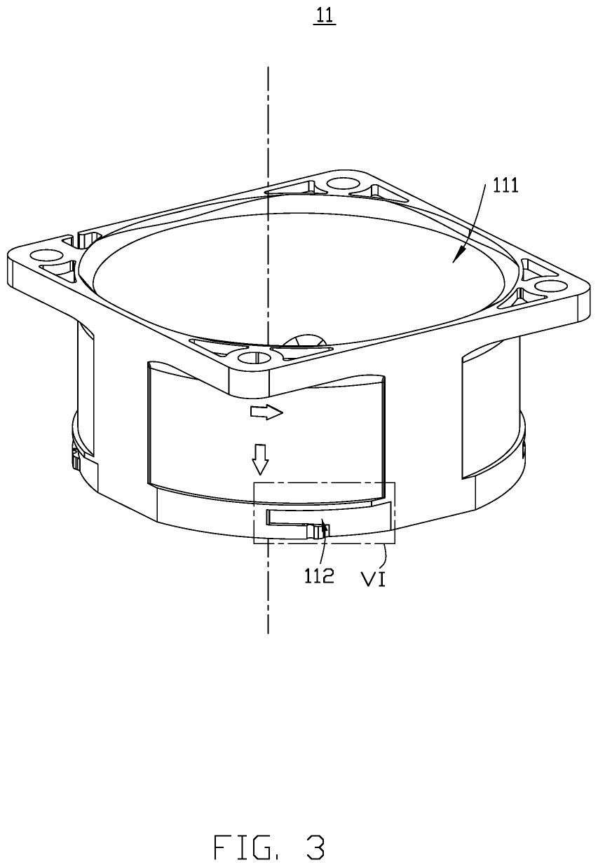

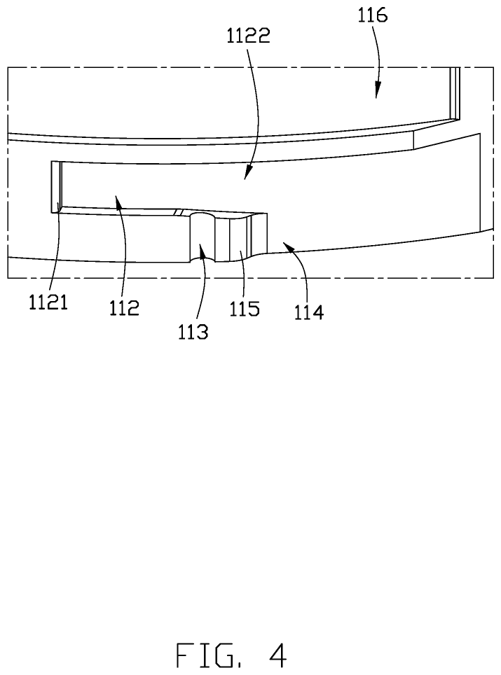

Referring to FIGS. 3 and 4, the inlet frame 11 is substantially T-shaped. A first opening 111 is defined on a surface of the inlet frame 11 away from the output frame 12, and the inlet fan 20 is accommodated in the first opening 111. Four first grooves 112 and four second grooves 113 are defined on an end of a periphery 116 of the inlet frame 11 adjacent to the output frame 12. Each first groove 112 includes a sidewall 1121. The sidewall 1121 is parallel to a central axis of the inlet frame 11. An opening 1122 of the second groove 113 is located on a side of the first groove 112 facing away from the sidewall 1121. Each second groove 113 is defined between the first groove 112 and the output frame 12, and the second groove 113 is interconnected with the first groove 112. A third groove 114 is defined on the periphery 116 of the inlet frame 11. The third groove 114 communicates with the first groove 112. A transiting surface 115 is formed between the third groove 114 and the second groove 113. The transiting surface 115 can be a sloped surface or an arcuate surface.

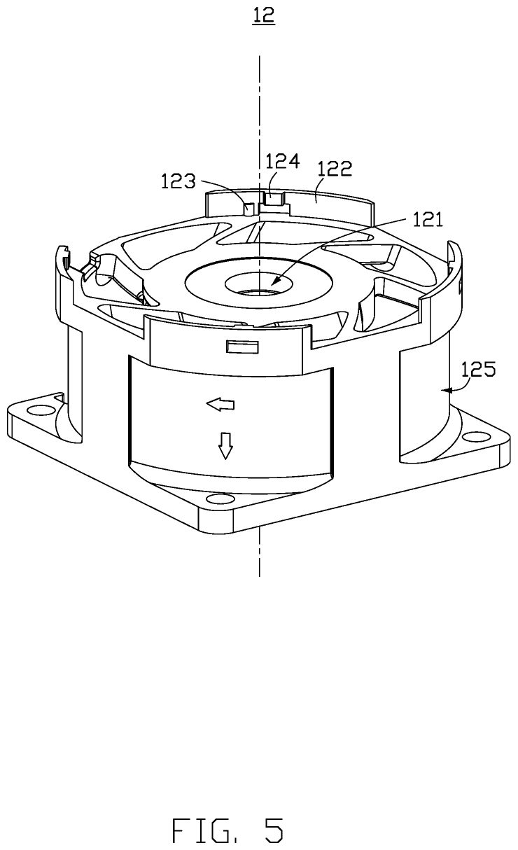

Referring to FIG. 5, the output frame 12 is substantially T-shaped. A second opening 121 is defined on a surface of the output frame 12 away from the inlet frame 11, and the output fan 30 is accommodated in the second opening 121. Four clamping members 122 are disposed on a periphery 125 of the output frame 12. Each clamping member 122 is engaged with a corresponding first groove 112 and a corresponding second groove 113. Each clamping member 122 extends in a direction toward the inlet frame 11. A clamping post 123 and a positioning portion 124 are disposed on a side of each clamping member 122 near a central axis of the output frame 12. The clamping post 123 and the positioning portion 124 are staggered with each other along the central axis of the output frame 12. The clamping post 123 can engage with the second groove 113, and the positioning portion 124 can engage with the first groove 112.

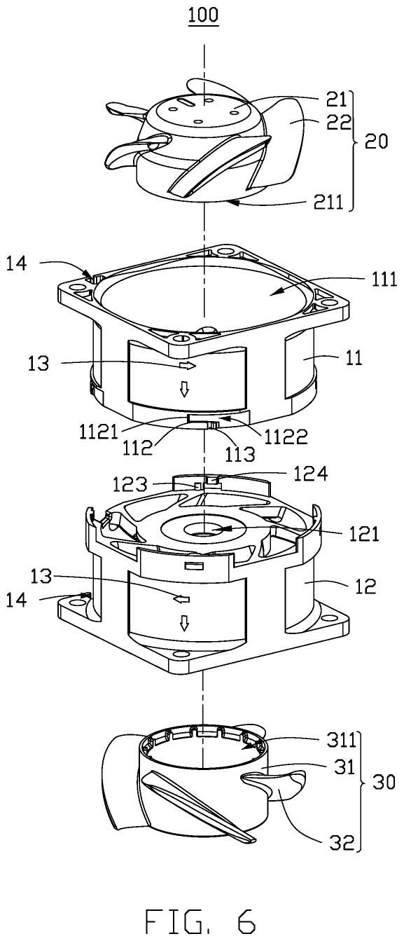

Referring to FIG. 6, during assembling the inlet frame 11 and the output frame 12, the central axis of the inlet frame 11 and the central axis the output frame 12 are first disposed to be aligned with each other. The positioning portion 124 enters the opening 1122. Then, the positioning portion 124 rotates from the opening 1122 toward the sidewall 1121, while the clamping post 123 rotates toward the second groove 113 until the clamping post 123 is securely engaged in the second groove 113. The positioning portion 124 abuts against the sidewall 1121, thereby preventing further rotation between the inlet frame 11 and the output frame 12.

The clamping post 123 can be semicylindrical, and the second groove 113 is also semicylindrical, thereby allowing smooth engagement and disengagement between the clamping post 123 and the second groove 113.

In other embodiments, the number of second grooves 113, the number of clamping posts 123, the number of positioning portions 124, and the number of first grooves 112 are not limited to four.

In some embodiments, both the periphery 116 of the inlet frame 11 and the periphery 125 of the output frame 12 are marked with two arrows 13. The arrows 13 indicate a direction of movement of the inlet frame 11 or the output frame 12 during the assembling of the frame 10, so that the frame 10 can be assembled quickly and accurately.

Fourth grooves 14 are defined on a side of the first opening 111 and a side of the second opening 121. Wires (not shown) can be inserted into the fourth grooves 14 to electrically connect the inlet fan 20 and the output fan 30.

The inlet fan 20 is disposed within the inlet frame 11. The inlet fan 20 includes an inlet body 21 and a plurality of inlet blades 22. The inlet blades 22 are spaced apart from each other and disposed around the inlet body 21. An inlet receiving cavity 211 is defined on a side of the inlet body 21 closing to the output fan 30. An inlet motor (not shown) is disposed within the inlet receiving cavity 211. The inlet motor is connected to a bottom of the first opening 111 and the inlet body 21. The inlet motor can drive the inlet body 21 to rotate, causing the inlet blades 22 to rotate.

The output fan 30 is disposed within the output frame 12 and opposite to the inlet fan 20. The output fan 30 includes an output body 31 and a plurality of output blades 32. The output blades 32 are spaced apart from each other and disposed around the output body 31. An output receiving cavity 311 is defined on a side of the output body 31 closing to the inlet fan 20. An output motor (not shown) is disposed within the output receiving cavity 311. The output motor is connected to a bottom of the second opening 121 and the output body 31. The output motor can drive the output body 31, causing the output blades 32 to rotate. Rotation directions of the inlet blade 22 and the outlet body 31 are opposite to each other, with one rotating clockwise and the other rotating counterclockwise.

The inlet body 21 and the output body 31 are driven by two motors, so that a rotational speed of the inlet body 21 and a rotational speed of the output body 31 can be independent from each other to prevent resonance between the inlet body 21 and the output body 31, thereby reducing noise of the counter-rotating fan 100 during operation.

In other embodiments, the inlet body 21 and the output body 31 can be driven by a same motor.

Since the rotational direction of the output blades 32 is opposite to the rotational direction of the inlet blades 22, overlap between the inlet blades 22 and the output blades 32 during the periodic rotation of the counter-rotating fan 100 can be avoided, so that an aerodynamic performance of the output blades 32 can be enhanced and a noise output of the counter-rotating fan 100 can be reduced.

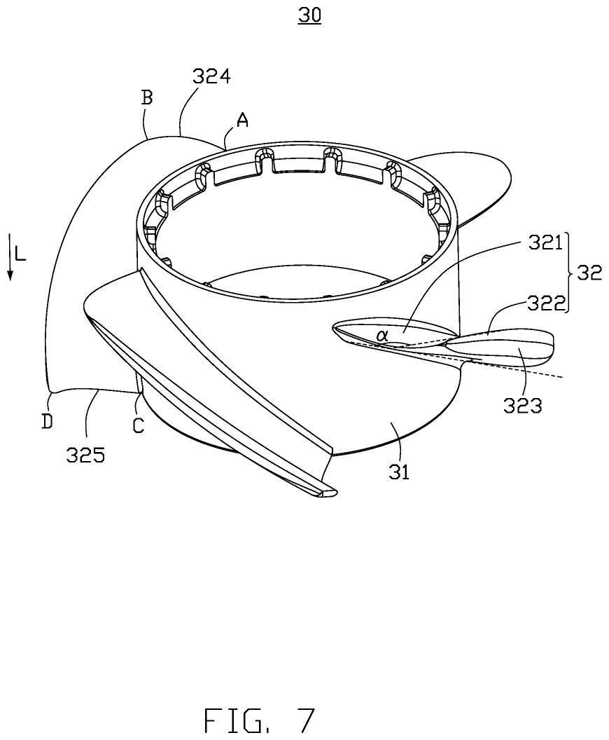

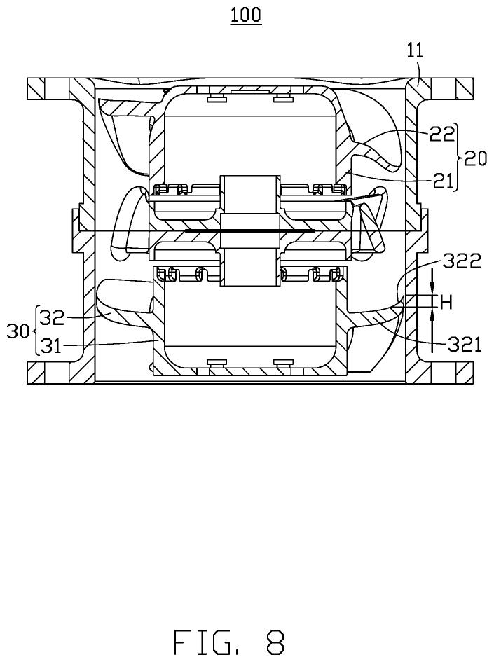

Referring to FIGS. 7 and 8, an end of each output blade 32 away from the output body 31 curves towards the inlet blades 22. The whole output blade 32 is curved. Each output blades 32 includes a blade body 321 and a curved portion 322. Two ends of the blade body 321 are respectively connected to the output body 31 and the curved portion 322. The curved portion 322 curves towards the inlet blades 22 relative to the blade body 321 to increase a surface area of the output blade 32, so that a radial movement of fluid near the output blade 32 can be suppressed, allowing more fluid to be transported axially to improve an operational efficiency of the counter-rotating fan 100 and to reduce the noise of the output blade 32. In the embodiment, the fluid is hot air.

In the embodiment, the curved portion 322 is an entire edge of the output blade 32 away from the output body 31.

In other embodiments, the curved portion 322 can be a portion of the edge of the output blade 32 away from the output body 31. For example, the curved portion 322 can be a middle portion of the edge of the output blade 32.

A height H of the curved portion 322 along a direction away from the inlet fan relative to the blade body 321 is greater than 1 mm and less than 10 mm. The height H does not include a thickness of the output blade 32 itself. In some embodiments, the height H can be 1 mm, 3 mm, 5 mm, 7 mm, or 9 mm. The height H with such value can suppress the radial movement of fluid near the output blades 32, thereby allowing more fluid to be transported axially to improve an operational efficiency of the counter-rotating fan 100.

In the embodiment, the height H of the curved portion 322 gradually increases along a direction L away from the inlet fan 20. In other embodiments, the height H of the curved portion 322 can remain constant.

In some embodiments, an included angle α between the curved portion 322 and the blade body 321 is greater than 90 degrees and less than 180 degrees. In some embodiments, the included angle α can be 100 degrees, 120 degrees, 140 degrees, 160 degrees, or 170 degrees. The included angle α with such value can reduce flow field losses and enhance the operational efficiency of the counter-rotating fan 100, and further reduce the noise of the output blades 32.

In some embodiments, the blade body 321 and the curved portion 322 are connected through an arcuate surface 323, to reduce flow field losses and enhances an aesthetic appearance of the output blades 32.

In some embodiments, other two opposite edges of each output blade 32 connecting the blade body 321 is an output front edge 324 and an output rear edge 325. The outlet front edge 324 includes a first end A and an end second B opposite to the first end A. The first end A is connected to the outlet body 31, along the direction L away from the inlet fan 20, the output front edge 324 extends from the first end A to the end second B. The output rear edge 325 includes a third end C and a fourth end D opposite to the third end C. The third end C is connected to the outlet body 31, along the direction L away from the inlet fan 20, the output rear edge 325 extends from the third end C to the fourth end D, to suppress the radial movement of fluid near the output blades 32, allowing more fluid to be transported axially, which improves an operational efficiency of the counter-rotating fan 100.

In some embodiments, each of the output front edge 324 and the output rear edge 325 curves from the output body 31 away from the inlet blades 22, so that a radial component of fluid flowing on surfaces of the inlet blades 22 and the output blades 32 can be reduced, so that more fluid can be directed along the axial direction, thereby reducing radial loss of the fluid, enhancing the operational efficiency and increasing the output air pressure and volume of the counter-rotating fan 100.

In some embodiments, a quantity of inlet blades 22 and a quantity of output blades 32 are different to avoid an overlap between a frequency of the inlet blades 22 and a frequency of the output blades 32, thus preventing resonance occurring between the inlet blades 22 and output blades 32. In some embodiments, the inlet fan 20 includes four inlet blades 22, and the output fan 30 includes five output blades 32. In some embodiments, the inlet fan 20 includes three inlet blades 22, and the output fan 30 includes four output blades 32. In other embodiments, the number of inlet blades 22 and the number of output blades 32 are the same.

In some embodiments, the output body 31 and the output blades 32 can be integrally formed. In the embodiment, the output body 31 and the output blades 32 are formed by molding. In other embodiments, the output body 31 and the output blades 32 are connected together by bolting or welding.

The end of each output blade 32 away from the output body 31 curves towards the inlet blades 22. The curved portion 322 curve towards the inlet blades 22 relative to the blade body 321 to increase a surface area of the output blade 32, so that a radial movement of fluid near the output blade 32 can be suppressed, allowing more fluid to be transported axially to improve an operational efficiency of the counter-rotating fan 100. Since the rotational direction of the output blades 32 is opposite to the rotational direction of the inlet blades 22, overlap between the inlet blades 22 and the output blades 32 during the periodic rotation of the counter-rotating fan 100 can be avoided, so that an aerodynamic performance of the output blades 32 can be enhanced and a noise output of the counter-rotating fan 100 can be reduced.

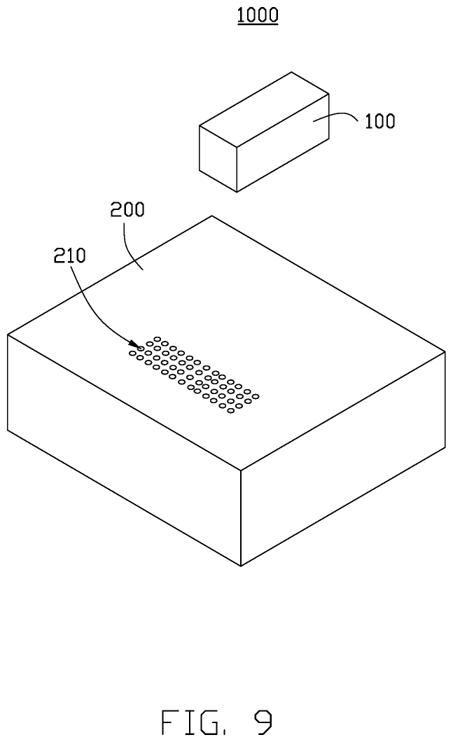

Referring to FIG. 9, an embodiment of the present disclosure further provides a heat dissipating device 1000. The heat dissipating device 1000 includes the counter-rotating fan 100 and a heat dissipating body 200. The counter-rotating fan 100 is disposed in the heat dissipating body 200. A plurality of heat dissipating holes 210 defined on the heat dissipating body 200 to discharge fluid from the counter-rotating fan 100. The heat dissipating device 1000 can be a computer, a server, a communication equipment, a network equipment, etc.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A counter-rotating fan comprising:
a frame;
an inlet fan disposed in the frame, the inlet fan comprising an inlet body and a plurality of inlet blades, the plurality of inlet blades spaced apart from each other and disposed around the inlet body; and
an output fan disposed in the frame and opposite to the inlet fan, the output fan comprising an output body and a plurality of output blades, the plurality of output blades spaced apart from each other and disposed around the output body, a rotational direction of the plurality of output blades opposite to a rotational direction of the plurality of inlet blades, an end of each of the plurality of output blades away from the output body curving towards the plurality of inlet blades.

2. The counter-rotating fan of claim 1, wherein each of the plurality of output blades comprises a blade body and a curved portion, two ends of the blade body are respectively connected to the output body and the curved portion, and the curved portion curves towards the plurality of inlet blades relative to the blade body.

3. The counter-rotating fan of claim 2, wherein a height of the curved portion along a direction away from the inlet fan relative to the blade body is greater than 1 mm and less than 10 mm.

4. The counter-rotating fan of claim 2, wherein an included angle between the curved portion and the blade body is greater than 90 degrees and less than 180 degrees.

5. The counter-rotating fan of claim 2, wherein the blade body and the curved portion are connected through an arcuate surface.

6. The counter-rotating fan of claim 1, wherein each of the plurality of output blade comprises an output front edge and an output rear edge opposite to the output front edge, each of the output front edge and the output rear edge is connected to the blade body, the outlet front edge comprises a first end and an end second opposite to the first end, the first end is connected to the outlet body, along the direction away from the inlet fan, the output front edge extends from the first end to the end second, the output rear edge comprises a third end and a fourth end opposite to the third end, the third end is connected to the outlet body, along the direction away from the inlet fan, the output rear edge extends from the third end to the fourth end.

7. The counter-rotating fan of claim 6, wherein each of the output front edge and the output rear edge is curved from the output body away from the plurality of inlet blades.

8. The counter-rotating fan of claim 1, wherein a quantity of the plurality of inlet blades is different from a quantity of the plurality of output blades.

9. The counter-rotating fan of claim 1, wherein the output body and the plurality of output blades are integrally formed.

10. A heat dissipating device comprising:
a counter-rotating fan comprising
a frame;
an inlet fan disposed in the frame, the inlet fan comprising an inlet body and a plurality of inlet blades, the plurality of inlet blades spaced apart from each other and disposed around the inlet body;
an output fan disposed in the frame and opposite to the inlet fan, the output fan comprising an output body and a plurality of output blades, the plurality of output blades spaced apart from each other and disposed around the output body, a rotational direction of the plurality of output blades opposite to a rotational direction of the plurality of inlet blades, an end of each of the plurality of output blades away from the output body curving towards the plurality of inlet blades; and
a heat dissipating body, the counter-rotating fan disposed in the heat dissipating body, a plurality of heat dissipating holes defined on the heat dissipating body and configured to discharge fluid from the counter-rotating fan.

11. The heat dissipating device of claim 10, wherein each of the plurality of output blades comprises a blade body and a curved portion, two ends of the blade body are respectively connected to the output body and the curved portion, and the curved portion curves towards the plurality of inlet blades relative to the blade body.

12. The heat dissipating device of claim 11, wherein a height of the curved portion along a direction away from the inlet fan relative to the blade body is greater than 1 mm and less than 10 mm.

13. The heat dissipating device of claim 11, wherein an included angle between the curved portion and the blade body is greater than 90 degrees and less than 180 degrees.

14. The heat dissipating device of claim 11, wherein the blade body and the curved portion are connected through an arcuate surface.

15. The heat dissipating device of claim 10, wherein each of the plurality of output blade comprises an output front edge and an output rear edge opposite to the output front edge, each of the output front edge and the output rear edge is connected to the blade body, the outlet front edge comprises a first end and an end second opposite to the first end, the first end is connected to the outlet body, along the direction away from the inlet fan, the output front edge extends from the first end to the end second, the output rear edge comprises a third end and a fourth end opposite to the third end, the third end is connected to the outlet body, along the direction away from the inlet fan, the output rear edge extends from the third end to the fourth end.

16. The heat dissipating device of claim 15, wherein each of the output front edge and the output rear edge is curved from the output body away from the plurality of inlet blades.

17. The heat dissipating device of claim 10, wherein a quantity of the plurality of inlet blades is different from a quantity of the plurality of output blades.

18. The heat dissipating device of claim 10, wherein the output body and the plurality of output blades are integrally formed.
